(19) United States
(12) Patent Application Publication
(10) Pub. No.: US 2014/0249871 A1
(43) Pub. Date: Sep. 4, 2014

(54) Method And System For Managing Vehicles Offered For Rental

(71) Applicant: Bluecarsharing, Vaucresson (FR)

(72) Inventors: Clement Lambrinos, Montreuil (FR); Yousra Chebbi, Issy Les Moulineaux (FR); Aymeric Augustin, Ville D'Avray (FR); Raphael Barrois, Paris (FR); Sylvain Geron, Meudon (FR); Antoine Geron, Viroflay (FR); Francis Aaron, Houilles (FR)

(73) Assignee: BLUECARSHARING, Vaucresson (FR)

(21) Appl. No.: 14/348,011

(22) PCT Filed: Sep. 27, 2012
(86) PCT No.: PCT/FR2012/052167

§ 371 Date: Mar. 27, 2014

(30) Foreign Application Priority Data
Sep. 30, 2011 (FR) 11 58781

(51) Int. Cl. G06Q 10/02; G06Q 50/30

(52) U.S. Cl. CPC G06Q 10/02; G06Q 50/30
USPC 705/5

(57) ABSTRACT

The invention relates to a method (100) for managing vehicles offered for rental in a site, termed the rental site, comprising a plurality of vehicles, said method comprising the following steps: —identification (102) of a user with the aid of at least one identification datum, and —selection (120) of a vehicle from among said plurality of vehicles as a function of at least one predetermined criterion, termed the attribution criterion, and of data (D) relating to each of the vehicles of said plurality. The invention also relates to a method of reserving a vehicle implementing the method of management according to the invention. The invention also relates to a management and reservation system implementing the method according to the invention.

The present invention relates to a method for managing vehicles available for rental. It also relates to a system implementing such a method and application of such a method or system to an installation for the automated rental of vehicles, in particular electric vehicles.

The field of the invention is the field of managing vehicles available for rental and more particularly the field of managing electric vehicles available for rental. The invention relates more particularly to methods and systems for selecting and reserving a vehicle available for rental from a plurality of vehicles.

### STATE OF THE ART

Automated vehicle rental is a field experiencing rapid growth. In population centres where it is desirable to reduce the number of vehicles present in the area, automated vehicle rental systems are being established.

Thus, many towns have put in place a system for the automated rental of bicycles. In the existing systems, each user intending to rent a bicycle must carry an identification card after having taken out a subscription. The user, carrying his identification card, then goes to a rental site at which several bicycles are available.

The user intending to rent a bicycle then presents his card to identification means that allow an anti-theft device to be unlocked. The user can then take the bicycle. After use, the bicycle is returned to a rental site which can be the same rental site or another.

However, the current methods and systems for the automated rental of vehicles have a major drawback.

A user attending a rental site himself selects the vehicle to be rented. This selection is carried out by a cursory inspection of a few features of the vehicle, essentially consisting of external features that are visually accessible to the user. With the current methods and systems, the user does not even have the opportunity to test a vehicle before renting it to ensure that the vehicle is working properly.

Such cursory selection of a vehicle available for rental presents the risk of accidents for the user. In fact, it is possible for the user to overlook the malfunction of an essential element of the vehicle, for example the vehicle brakes, which may constitute a grave danger for the user as well as for people in the vicinity. Moreover, a vehicle rented while malfunctioning may force the user to abandon the vehicle in a place other than a rental site, which represents the risk of theft and additional damage to the vehicle thus putting the user and the vehicle rental agent in a difficult situation. Finally, the use of a malfunctioning vehicle can make the existing problem worse and thus introduce more significant maintenance costs.

A purpose of the invention is to remedy the abovementioned drawbacks.

Another purpose of the invention is to propose an automated method for managing vehicles available for rental that is more efficient than the current methods and systems.

Another purpose of the invention is to propose an automated method for managing vehicles available for rental that makes it possible to ensure greater safety for the user and his environment.

Finally, another purpose of the invention is to propose an automated method for managing vehicles available for rental that makes it possible to ensure greater security for the vehicles.

### DISCLOSURE OF THE INVENTION

The invention proposes to achieve at least one of the abovementioned purposes through a method for managing vehicles available for rental at a site, called rental site, comprising a plurality of vehicles, said method comprising the following steps:
identifying a user by means of at least one item of identification data, and
selecting a vehicle from said plurality of vehicles as a function of at least one predetermined criterion, called allocation criterion, and data relating to each of the vehicles of said plurality.

The method according to the invention therefore proposes an automated selection of a vehicle from a plurality of vehicles as a function of at least one allocation criterion and data relating to each of the vehicles present at the rental site.

Thus, when a user, wishing to rent a vehicle, identifies himself in order to rent a vehicle, he is not limited to a simple visual inspection in order to choose the vehicle that he will rent. The method allows this selection to be carried out as a function of data relating to each of the vehicles present on the site and allocation criteria which are more specific than a simple visual inspection.

The method according to the invention makes it possible to ensure that the user does not rent a defective vehicle and thus has a vehicle that he can actually use and that operates correctly. The method according to the invention makes it possible to ensure that the user does not rent a vehicle suffering from a malfunction which cannot be detected visually or when the vehicle is collected from the rental site. Thus, the method according to the invention makes it possible to carry out automated management of vehicles available for rental more efficiently than the existing methods and systems.

Moreover, the method according to the invention offers the user and his environment greater safety by avoiding the use of a defective vehicle in traffic. In addition, the method according to the invention makes it possible to avoid the use of a defective vehicle, which could make its malfunction worse and thus increase the repair costs thereof or compel the user to abandon it at a site other than the rental site and thus cause the loss or theft of the vehicle.

Advantageously the selection step is carried out following the identification step. In this particular case, the selection step is not carried until an identification step has been performed.

Advantageously, the selection of a vehicle can be carried out according to a predetermined algorithm taking into account on the one hand at least one allocation criterion, and on the other hand the data relating to the vehicles.

Preferably, the selection step is carried out as a function of at least two predetermined criteria. In the event that several allocation criteria are taken into account in the algorithm, these criteria can be taken into account one after the other or simultaneously. The criteria can also be weighted when they are taken into account simultaneously, a higher rank being given to one criterion than to another criterion.

Advantageously, the at least one allocation criterion can be at least one criterion relating to a journey for which the user wishes to rent a vehicle.

The criterion relating to the journey can be a criterion relating to the journey distance, or the journey distance.

The criterion relating to the journey can be a criterion relating to the type of journey, or to the route plan, for example one or more stops/stages on the journey, a route on main roads or a route in town.

Advantageously, the at least one allocation criterion can be a criterion relating to a profile of said user.

Such a criterion can relate to the nature of the user, for example a criterion relating to the date/time period since the person obtained their licence, the age of the person, a disability affecting the user, or a preference criterion relating to a vehicle. The age of the driver or the date on which the licence was obtained makes it possible for example to deduce his experience and to establish stricter safety criteria.

Such a criterion can moreover be a criterion relating to the number of persons accompanying the user, the type of persons accompanying the user, for example a child, or to equipment that the user wishes to transport in the vehicle that he rents. This can allow criteria relating to the size or the fittings of the vehicle.

Moreover, the at least one allocation criterion can be a criterion relating to a state of the vehicle, for example a level of charge of the vehicle when the vehicle is an electric vehicle, an operational status of the vehicle, namely for example if the vehicle is in serviceable condition, malfunctioning but capable of being driven, or malfunctioning but not capable of being driven.

According to an advantageous version of the invention, the selection of a vehicle can be carried out as a function of several allocation criteria, classified according to several priority levels.

Each priority level can comprise one or more allocation criteria. A priority level can be an essential priority level or an optional priority level.

In the case of a plurality of priority levels, the allocation criteria of the highest priority level are the first to be taken into account during the allocation, and so on.

When a criterion is defined as essential, this means that a vehicle which does not fulfil all these criteria cannot be allocated to a user. A criterion can be defined as essential according to the profile of the user or his journey (number of seats available in the vehicle as a function of the number of passengers, presence of a child seat if a child is among the passengers). It can also be defined as essential for any user (level of charge of a battery greater than a minimum level, vehicle capable of being driven, vehicle available, etc.). In the latter case, signalling means can show that the vehicle cannot be rented, which makes it possible to inform users of the number of vehicles at the site that can potentially be allocated.

A criterion relating to the journey, and/or a criterion relating to a user profile can be given beforehand, for example during a step of reserving a vehicle or during a step of renting the vehicle at a rental site or during a step of subscribing to a rental plan.

According to the invention, at least one allocation criterion and/or at least one priority level and/or at least one criterion of a priority level can be added, removed or modified before rental, at a rental site and/or on a subscription site and/or by connection to a central site over a communication network.

According to the invention at least one allocation criterion and/or at least one priority level and/or at least one criterion of a given safety level can be defined in common for a plurality of future rentals.

The method according to the invention can moreover comprise a step of defining on the fly at least one allocation criterion after the identification step and before the selection step. Thus, a new criterion can be defined for each rental.

Certain criteria, particularly those relating to the safety or to the state of the vehicle, can also be defined in such a way as to be fixed and not user-modifiable, for all vehicles, all subscriptions, etc.

According to the invention the data relating to the vehicles can comprise data relating:
to an operational status of the vehicle or of an element of the vehicle, for example a level of charge of a battery of a vehicle,
to the availability of the vehicle for rental,
to the dimensions of the vehicle, and/or
to an option present in the vehicle, for example a child seat, mobility access, air-conditioning, etc.

Certain data relating to the vehicle, such as the level of charge, can be obtained directly from the vehicle, in particular through its connection to a charging terminal. Certain other data can be obtained through a central database to which each terminal allocating the vehicles is connected, data being in particular input to this database by an operator of the system.

When the vehicle is allocated to the user as a function of the allocation criteria, the method preferentially comprises a step of unlocking a device on said vehicle and/or at the rental site. It can also comprise a step of storing an item of identification data of the user in combination with an item of identification data of the vehicle.

Such a device can for example be a charging lid of the vehicle when the vehicle is an electric vehicle, the engine of the vehicle, the brakes of the vehicle, or an opening of the vehicle.

A prior step of requesting acceptance of the vehicle by the user can be transmitted. The above steps are then carried out if, and only if, the user accepts the vehicle. If he rejects it, he can state the reason and another vehicle can be allocated to him.

Advantageously, when no vehicle can be selected at the rental site, called predetermined rental site, at which the identification step is carried out, the selection step can comprise selecting a vehicle at another rental site remote from said predetermined rental site as a function of the at least one allocation criterion and a distance criterion of said other remote rental site from said predetermined rental site.

In this case, the method according to the invention can comprise moreover a step of reserving the selected vehicle for the user at said other remote rental site for a predetermined period.

In fact, the selected vehicle can be a vehicle which is at a rental site remote from the identification site. This occurs particularly when there is no vehicle available at the identification site or when none of the vehicles at the identification site correspond to one or all of the allocation criteria defined as being essential.

If no vehicle fulfils the essential criteria relating to the user, the vehicles parked in one or more of the rental sites nearest to the identification site are examined as a function of a criterion, of distance for example, or of a site chosen by the user, in order to determine the vehicle to allocate to the user.

It is also possible to indicate several vehicles fulfilling the essential criteria in the surrounding sites (and not only a single one) so that the user may choose his preferred rental site.

The system can in particular be configured so that each site is assigned a group of a predetermined number of sites nearest to this site, the selection step being carried out from the vehicles of this group. This avoids carrying out at each selection step a calculation of the distance of the different sites from the site in question.

The method according to the invention can then comprise a transmission of information and direction data so that the user may go to the site in question.

It should be noted that this functionality is optional and that the method can simply notify the user of a vehicle rental rejection at the identification site in the case where the essential criteria are not fulfilled by the vehicles situated there.

According to another aspect of the invention, a method is proposed for the remote reservation of a vehicle available for rental at one or more sites, called rental sites, comprising a plurality of vehicles, said met hod comprising the following steps carried out over a communication network:
selecting a vehicle in accordance with the management method according to the invention, the vehicle being selected from a site distant from the identification site, and
reserving said selected vehicle.

The step of reserving the vehicle can for example comprise a step making the vehicle unavailable for rental by other users.

The step of selecting a vehicle located at a given site can be carried out from a rental site near the given site, when no vehicle can be made available for rental to a user which who has attended this nearby site.

The selection step can also be carried out remotely from any rental site, for example from the user's home, his place of work, or a place of entertainment or other. It can for example be carried out from a PC or a mobile terminal (PDA, smartphone, etc.) of the user.

The reservation can be associated with a time slot determined in advance by the user in which case the selection step is then carried out in the determined time slot or in a time slot preceding the determined time slot by a predetermined period (for example, 1 hour). A message can be sent to the user indicating to him the parking space of the reserved vehicle.

In this case, when there is no vehicle fulfilling the essential criteria at the site chosen by the user when the selection step is carried out, a message can be sent to an operator of the service requesting him to bring a vehicle to this site.

Advantageously, the reservation step can comprise a step of triggering a countdown of a period of time during which the vehicle is reserved, and, therefore, unavailable for rental.

The predetermined period of time can be a fixed period, or a period calculated at each reservation, for example as a function of the distance to be covered to reach the rental site from the reservation site.

The method according to the invention can moreover comprise a transmission to the user of information or direction data so that the user may reach the rental site at which the reserved vehicle is located.

The method of reservation also comprises preferably the unlocking step, this step being triggered by identification at the rental site of the user to whom the vehicle has been allocated.

The management method according to the invention and/or the reservation method according to the invention can be used for the automated rental of electric vehicles available for rental at one or more sites.

According to yet another aspect of the invention, a management system is proposed for vehicles available for rental at a site, called rental site, comprising a plurality of vehicles, said system being in particular provided for implementing the management method according to the invention, said system comprising:
at least one means of identifying a user by means of at least one item of identification data, and
at least one means of selecting a vehicle from said plurality of vehicles as a function of at least one predetermined criterion, called allocation criterion, and data relating to each of the vehicles of said plurality of vehicles.

According to yet another aspect of the invention, a remote reservation system is proposed for a vehicle available for rental at one or more sites, called rental sites, comprising a plurality of vehicles, said system being in particular provided for implementing the reservation method according to the invention, said system comprising:
a system for managing vehicles according to the invention, and
means for the remote reservation of the selected vehicle.

Other advantages and characteristics will become apparent on examination of the detailed description of embodiments which are in no way limitative, and the attached diagrams, in which:

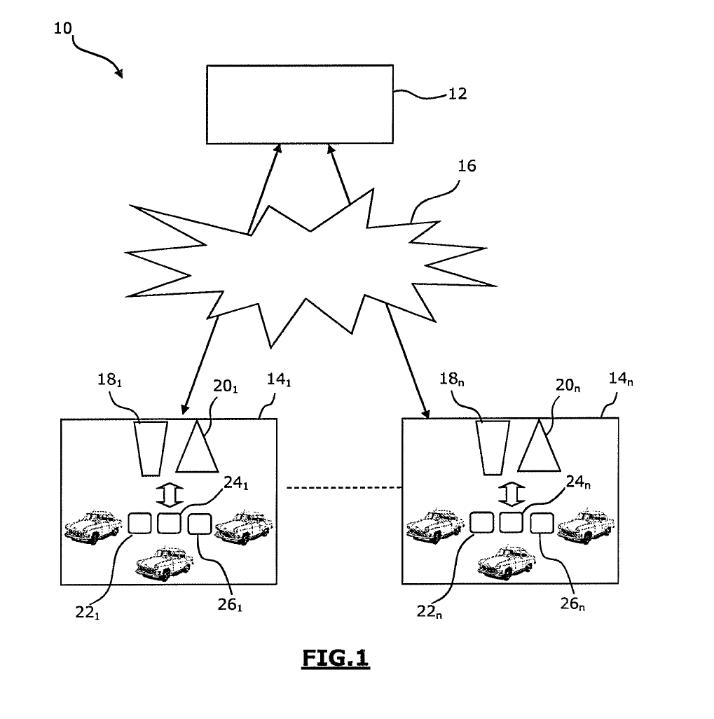

FIG. 1 is a diagrammatic representation of an overall management system for a fleet of electric vehicles available for rental.

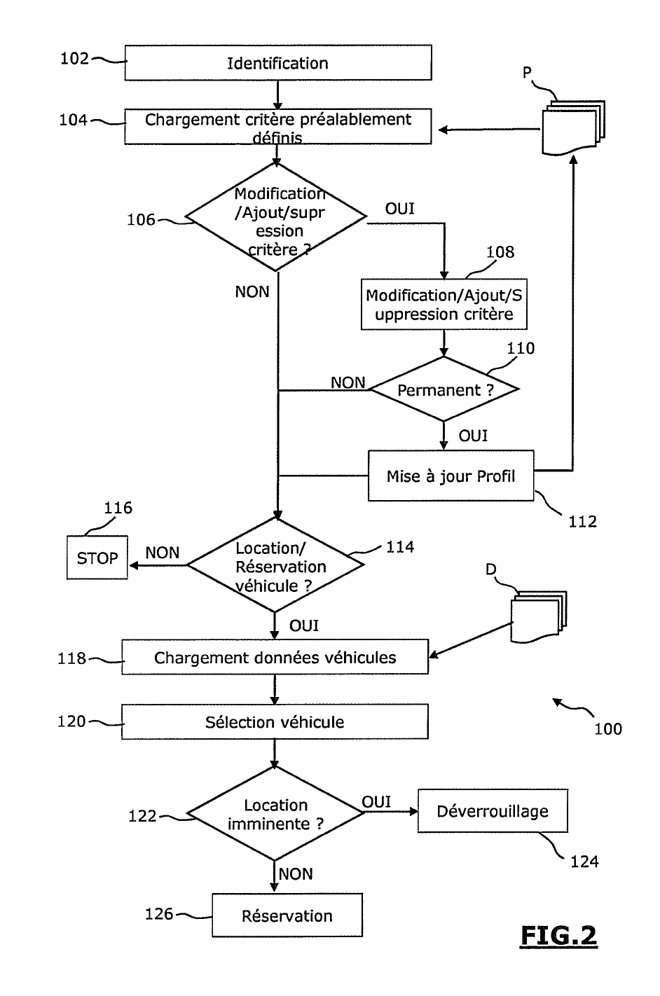

FIG. 2 is a diagrammatic representation in the form of a diagram of a method for reserving a vehicle according to the invention; and

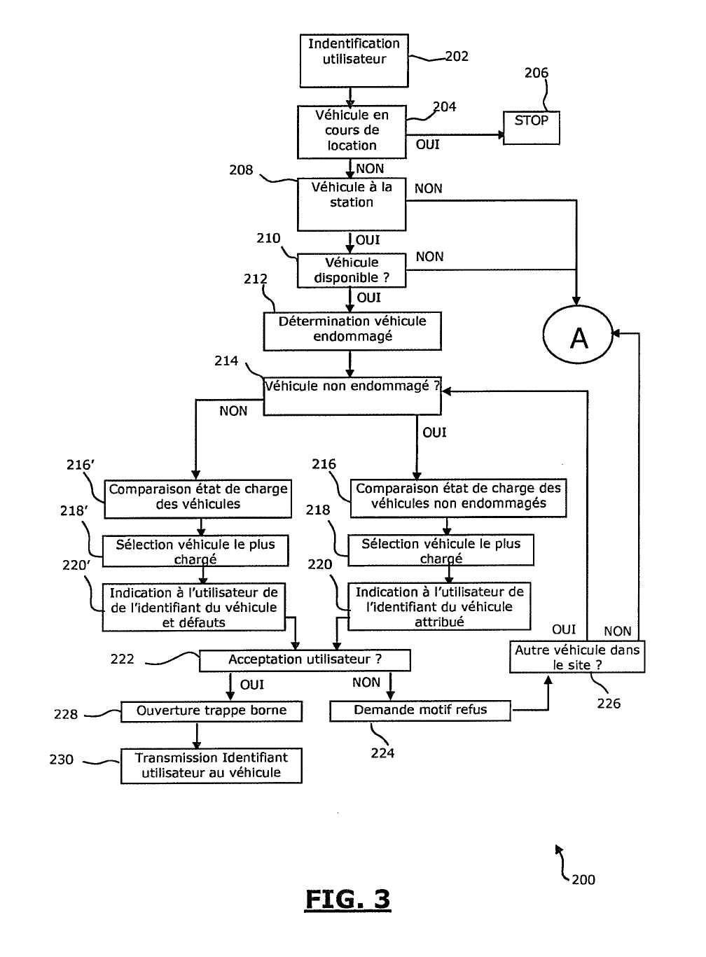

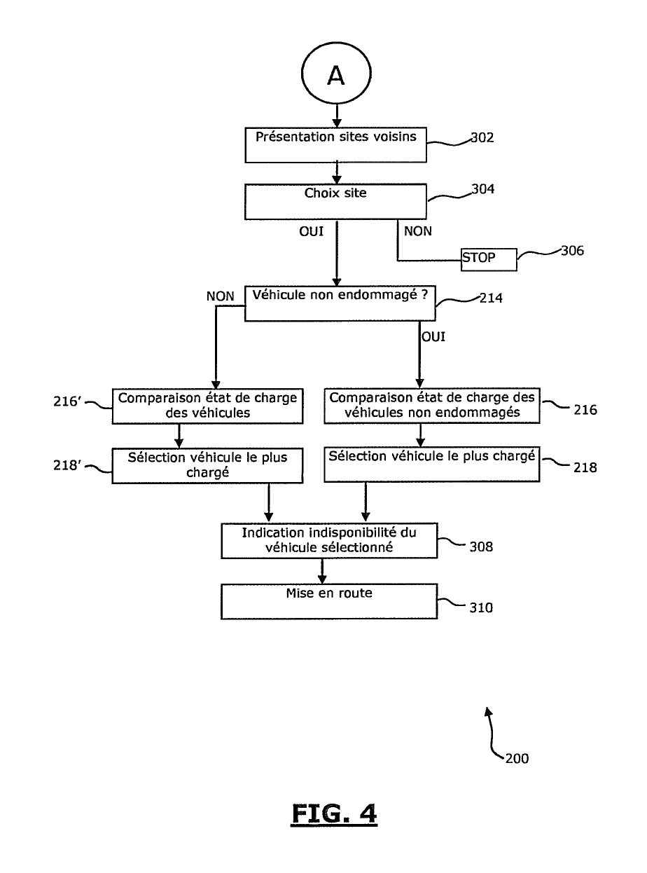

FIGS. 3 and 4 are diagrammatic representations in the form of a diagram of a method for reserving a vehicle applied to the rental of electric vehicles.

In the figures and in the remainder of the description, the elements which are common to several figures retain the same reference.

Firstly a general system for the automated rental of automatic vehicles will be described, in which the method according to the invention is implemented.

FIG. 1 is a diagrammatic representation of an overall management system for a fleet of electric vehicles available for rental.

The system 10 shown in FIG. 1 comprises a central site 12 (also called central agency in the remainder of the description) connected to several sites—or stations—14₁-14ₙ called rental sites over a wireless communication network 16, for example GPRS, or a wired network, for example of DSL type. Preferably, each site is connected to the central site via two separate networks, which enables continuous connection even if one of the networks fails.

Each rental site comprises a subscription terminal 18 for registering a new subscriber, a rental terminal 20 for the rental of a vehicle and several charging terminals 22-26, each charging terminal being provided for charging a vehicle equipped with an electric battery at a parking space.

The central site 12 can be connected directly to each of the terminals of a rental site 14 over the network 16 or only to the subscription terminal and/or to the rental terminal and/or to the recharging terminals 22-26.

At least two terminals of a rental site are connected to each other over a wired connection (not shown).

The central site 12 is also arranged in order to be connected to an electric vehicle comprising a data connector to one or more elements of the vehicle and/or a user communication interface, via a GPRS network. Each vehicle is for that reason equipped with a GSM chip.

The system makes it possible to manage a plurality of vehicles each comprising a control unit capable of communicating with the central agency and with different elements of the vehicle, and a user interface.

Users are capable of interacting with the different terminals as well as with the different elements of the vehicles.

FIG. 2 is a diagrammatic representation in the form of a diagram of a method for reserving a vehicle.

The method 100 comprises a first step 102 of identifying a user by means of an identifier, such as an RFID identifier. This step is in particular carried out at the user's home, from a computer or a smartphone, for example by connecting to an Internet site. Such a method could also be carried out from a rental terminal 18.

Once the user is identified, a profile associated with this user and comprising at least one allocation criterion is loaded during a step 104 when a previously defined allocation profile P exists for this user. When no defined profile P exists this step 104 is omitted and one moves on to the next step. If a profile P exists, it is loaded from the central site 12 which groups together all the user data.

During a step 106, the user is questioned in order to determine if he wishes to add or delete an allocation criterion, or modify an allocation criterion or a predefined saved allocation profile P.

If the user responds in the affirmative, a step 108 allows him to add or remove a criterion or to modify an existing criterion or profile P. During this step the user can also create an allocation profile P.

During a step 110, carried out after the modification/addition/deletion step 108, the user is questioned in order to determine if the modification(s)/addition(s)/deletion(s) that he has carried out during step 108 is (are) permanent and must be applied to at least one future rental.

If the user responds in the affirmative in step 110, the modification(s)/addition(s)/deletion(s) is (are) saved in an allocation profile P in local or remote storage means, for example at the central site 12, during step 112. Step 112 is then followed by step 114.

If the user responds in the negative in step 110, step 112 is not carried out and step 110 is followed by step 114. If the user responds in the negative in step 106, steps 108-112 are not carried out and step 106 is followed by step 114.

During step 114, the user is questioned in order to determine if he wishes to rent or reserve a vehicle.

If the user responds in the negative and wishes neither to rent nor to make a reservation then the method is stopped during step 116.

Thus, via steps 102-114 the user can define a new profile, modify it or consult it without necessarily wanting to rent or reserve a vehicle.

If the user responds in the affirmative in step 114 and wishes to rent or reserve a vehicle, data D relating to all the vehicles present at the rental site are loaded during step 118. These data D are for example saved in a vehicle profile associated with each vehicle, each vehicle being identified by an identifier, and stored in local or remote storage means, for example on the central site 12.

These data can also be obtained by polling one or more sensors at the charging terminals connected to vehicles or on the vehicles themselves. The level of charge of the battery can in particular be obtained in this way, using a pilot wire in the electrical connection. It can also be obtained directly from the vehicle.

These data D can comprise data relating to the operational status of the vehicle or to the operational status of a particular element of the vehicle, for example the battery of the vehicle, the brakes, the wheels, etc. or to the state of availability for rental of the vehicle, for example “reserved” or “free”.

As a function, on the one hand, of the allocation criteria, comprising therefore data originating from the allocation profile, and on the other hand, the data relating to each of the vehicles present at the rental site, the vehicle that best corresponds to the allocation profile is selected during step 120.

When no allocation criterion is defined by the user, the selection of the vehicle is carried out solely as a function of the allocation criterion or criteria relating only to the operational status of the vehicle, such as for example an allocation criterion relating to the state of charge of a battery, the operational status of an element of the vehicle such as the engine, the wheels, the brakes, etc.

The user is then questioned in step 122 in order to determine if he wishes rent the vehicle immediately.

If he responds in the affirmative in step 122, an identifier of the user is sent to the central site 12 which sends it back to the allocated vehicle so that the user can then unlock the doors of the vehicle using his means of identification.

A cover of the corresponding charging terminal is also unlocked in step 124 so that the user can access the means of charging the vehicle and stow this in a compartment overlaid by the cover. This is carried out using a signal sent from the central site 12 to the corresponding charging terminal 22 (through the rental terminal 20).

If he responds in the negative in step 122 the vehicle is reserved for a predetermined period in step 126. The steps that have to be taken by the user when he wishes to collect the reserved vehicle will be described later.

In a variant, the step of direct reserving the vehicle is only carried out if the period between the time of reservation and the time requested is less than a predetermined period, for example 1 hour.

In the case where the vehicle is on the other hand reserved for a requested time slot that is more than one hour from the time of reservation, the operation of selecting the vehicle is carried out an hour before the requested time slot. In this case, and if the site does not contains any vehicle, a request to an operator could be envisaged to bring one to the site so that it is present at the determined time slot. It should be noted that in the case where such a reservation is foreseen in advance, step 122 is carried out at the start of the process, before the step of allocating the vehicle.

FIGS. 3 and 4 are a diagrammatic representation of a method 200 for renting a vehicle implementing the methods according to the invention.

The user who wishes to rent a vehicle and is already a subscriber goes to a rental terminal situated at a rental site. He identifies himself at this terminal using his means of identification, particularly an RFID card that he passes over a reader on the terminal in step 202. However, he could identify himself in other ways, using a bar-code, or entering an identifier, etc.

Once the user is identified, it is verified that he does not have a vehicle rental in progress in step 204. In order to do this, the identifier of the user is searched for in a database of a central agency/site, or in an information system, which lists the rentals, in order to verify if a rental in progress is associated with an identifier of the user.

If the user already has a vehicle rental in progress, he is informed that he must return his vehicle and the process is stopped at step 206.

If this is not the case, the user is questioned in order to determine if he actually wishes to rent a vehicle. The method 200 can comprise additional steps, in particular the steps of accepting the terms and conditions and confirmation of being fit to drive.

Once the rental request is confirmed, the rental terminal 20 carries out a step of allocating a vehicle to the user. In order to do this the method comprises a step 208 to determine if a vehicle exists at the site. If there is no vehicle at the site, a step described later is carried out.

If at least one vehicle exists at the site the method determines in step 210 if at least one vehicle is available at the site. A verification takes place of the criteria of the first priority level, these criteria being the essential criteria, i.e. a vehicle which does not fulfil them cannot be allocated to a user. An available vehicle is a vehicle declared to be in a driveable state (state of charge of the battery sufficiently high, no major fault in the vehicle) and not reserved by a third party.

In order to determine this, the rental terminal queries a database stored locally or remotely and updated regularly with respect to the identifiers of vehicles connected to its charging terminals and the state of these vehicles. Information on the identifier of the vehicles and the state of charge originates from the vehicles themselves and is transmitted via the charging terminal to which the vehicle is connected. Information concerning the general state of the vehicle originates from an external source, for example an operator, and is transmitted from the central site 12 to the rental terminal 20.

With respect to this step 210, it is not carried out when a user identifies himself on the terminal with the purpose of taking a vehicle but permanently, in a periodic fashion. In fact, due to this periodic querying, the user can also be informed, before the database is queried, of the available vehicles present at the rental site using a display system.

In fact, the rental terminal 20 is configured to send an electrical signal to each charging terminal 22 when the status of the vehicle is modified. This allows the configuration to be modified, for example the colour, using a display means situated on each charging terminal. The display means can comprise one or more LEDs arranged on the rental terminal and which are lit or unlit depending on the status of the vehicle. These LEDs therefore make it possible to inform the user of the status of each of the vehicles using a colour code.

Once this first verification is carried out (first priority level), if there is no vehicle available, this is indicated to the user. The steps carried out at this point will be described later.

If there is only one vehicle available, it is allocated to the user.

If there are several, additional verification steps described hereafter are carried out. These verification steps are steps of verification of the criteria called “optional”, as it is possible to rent a vehicle without all these criteria being fulfilled.

Once the available vehicles are identified, a remote database is queried in step 212, in order to determine if these vehicles have suffered minor faults that are not yet resolved (second priority level).

As previously mentioned, these faults are reported by the users or the operators and stored in a central database.

Then in step 214 the vehicles which have not suffered any listed faults are selected in step 214. If there is only one vehicle corresponding to these criteria, it is allocated to the user.

If several vehicles correspond to this criterion, i.e. there are several vehicles which have not suffered faults, the state of charge of these vehicles is compared in step 216 (third priority level), and the vehicle with the highest charge level from these vehicles is determined in step 218, using the information received from the charging terminals. This vehicle is allocated to the user in step 220.

If in step 214, no vehicle corresponds to this criterion, i.e. that all the vehicles available have suffered faults, it is possible optionally to choose which fault appears to be the least serious, and from the vehicles which are declared “driveable” the vehicle with the highest charge level is selected and allocated to the user by carrying out steps 216′, 218′ and 220′ identical to steps 216, 218, and 220 respectively.

The user is then informed on a screen and/or by audible means, and/or by a change of lighting on the charging terminal, of the vehicle which has been allocated to him.

He is questioned in order to confirm if he wishes to rent this vehicle in step 222.

The user can go on to view the vehicle and accept or reject its rental. He generally has a predetermined period of time to do this, otherwise the rental is cancelled.

In step 222, if the user rejects the selected vehicle, a form is offered to him in step 224 on which he must state the reason for his rejection. This form is generally a multiple-choice questionnaire. It is then processed by the system and stored in a database relating to maintenance. The data from this form are generally processed by the central site and can serve to feed directly or indirectly (for example, after verification by an operator) the database concerned with damage to the vehicles or vehicle faults.

A step 226 determines if there are other vehicles at the site apart from the vehicle which has just been excluded.

If this is the case, the allocation steps 214 and 216-218 or 214 and 216′-218′ are repeated, excluding the vehicle rejected by the user from the available group.

If not, other steps described hereinafter are carried out.

In step 222, if the user accepts the selected vehicle, the lid of the charging terminal to which the vehicle is connected is unlocked during a step 228, so that the user can disconnect the vehicle without the need for a new identification on the vehicle terminal. The charging terminal in fact contains a compartment closed by a lid for stowing the cables for charging the vehicle.

In step 230, the rental terminal also transmits to the information system or central site, a message informing it that the vehicle is associated with the identified user. The system then transmits, during this same step 230, the identifier of the user to the vehicle, via a direct wireless link between the vehicle and the information system.

In the event that the user does not collect the vehicle, the lid of the terminal is locked again after a predetermined period of time, for example 10 minutes. There is no rental countdown. Once again the rental terminal transmits a message to the central agency, to inform it that the vehicle is no longer allocated.

In the case where:
step 208 determines that there is no vehicle at the site, or
step 210 determines that there is no available vehicle at the site, or
step 226 determines that there is no available vehicle at the site after the user has rejected a vehicle; the following steps are carried out with reference to FIG. 3.

Step 302 displays on a screen a map representing the nearest sites, in particular the 8 nearest sites, indicating the available vehicles for each site. The information on the map is transmitted by the central system, which obtains it from each of the rental terminals/sites. It should be noted that, in the central database, each site is associated with a group of the 8 nearest sites. It is therefore not necessary to make any calculation of distance in order to display the data relating to these sites which are the nearest to the current site where the user is located.

By viewing the map, the user can choose a site and reserve a vehicle in it during a step 304.

If the user does not choose any station/rental site the method is stopped during step 306.

If the user chooses a nearby site in order to reserve a vehicle at this nearby site, the rental site transmits to the information system the site chosen by the user.

Steps 214, 216′ and 218′ or steps 214, 216 and 218 previously described are carried out by the information system.

When the information system has allocated a vehicle to the user, the information system indicates that the allocated vehicle is unavailable in step 308 and transmits the information to the rental terminal of the nearby site or to the nearby site. The latter transmits a signal to the charging terminal at which the vehicle is charging in order to change the configuration of the display means thereof and thus signal that the vehicle is reserved and is unavailable for rental. When the information system marks the unavailability of the selected vehicle, it also triggers a countdown for a predetermined period, in particular 20 minutes, in step 310.

The user then goes to the site at which a vehicle is allocated to him. On arrival, he identifies himself on the terminal and, as described previously, he is asked if he accepts the vehicle. If he rejects the vehicle, the information system marks the latter again as available and the procedure described above is carried out. If he accepts it, as described above, the lid of the charging terminal associated with the vehicle is unlocked and the information relating to the user is transmitted to the vehicle.

However, if the user has not identified himself when the countdown triggered by the information system expires, the information system again indicates that the selected vehicle is available and the configuration of the display means shown on the charging terminal is again modified.

The invention comprises numerous variants:
the vehicle allocation criteria can in particular be different from that which has been described above or in a different order from the criteria described above. Other criteria can be examined such as the number of seats in the vehicle, the type of subscription of the user, etc.
additional criteria can be used (vehicle with the lowest mileage, etc.,
the algorithm for allocation of the vehicles can also be different from that indicated, for example several criteria can be examined together and not successively,
numerous steps are optional, in particular the step of acceptance and rejection by the user,
the elements of the system carrying out the different steps can also vary.

Of course the invention is not limited to the examples which have just been described.

1-17. (canceled)

18. A method for managing vehicles available for automated rental at a site, called rental site, including a plurality of vehicles, said method comprising the following steps:
identifying a user by means of at least one item of identification data, said identification comprising reading, by a reader, of said item of identification data in a means of identification, and
selecting a vehicle from said plurality of vehicles as a function of at least one predetermined criterion, called allocation criterion, and data relating to each of the vehicles of said plurality;
said method further comprising, prior to the selecting step, measuring, by one or more sensors arranged at said rental site or on said vehicles, data relating to an operational status of each of said vehicles or of an element of each of said vehicles, the data relating to an operational status constituting at least a portion of said data relating to each of the vehicles as a function of which said selection is carried out;
wherein, when no vehicle can be selected at the rental site at which the identification step is carried out, the selecting step further comprises selecting a vehicle at another rental site remote from said rental site as a function of at least one allocation criterion and a distance criterion of said other remote rental site from said rental site, and reserving the selected vehicle for the user at said other remote rental site for a predetermined period.

19. The method according to claim 18, wherein the selecting step is carried out following the step of identifying the user.

20. The method according to claim 18, wherein the at least one allocation criterion is a criterion that relates to at least one of:
a route for which the user wishes rent a vehicle,
a profile of said user, or
a state of the vehicle.

21. The method according to claim 18, wherein selecting a vehicle is carried out as a function of several allocation criteria, classified according to several priority levels.

22. The method according to claim 21, wherein at least one allocation criterion is considered essential, such that a vehicle not fulfilling this allocation criterion cannot be selected.

23. The method according to claim 21, wherein at least one of the priority levels or at least one criterion of a priority level is previously defined by the user.

24. The method according to claim 18, further comprising unlocking a device on said vehicle and/or at the rental site when the vehicle is allocated to the user.

25. The method according to claim 18, further comprising storing the item of identification data of the user in combination with an item of identification data of the vehicle when the vehicle is allocated to the user.

26. The method according to claim 18, wherein the vehicle is selected from one of the nearest rental sites, in particular the nearest 8 rental sites, from the identification site or from a site defined by the user, each site preferably being associated with the nearby sites in a database.

27. The method according to claim 18, wherein the reserving step comprises triggering a countdown of a period of time for which the vehicle is reserved.

28. The method according to claim 27, wherein the unlocking step is triggered by the identification of the user at the rental site, when the vehicle is located in a remote rental site.

29. The method claim 18, wherein the vehicles are electric vehicles available for rental at one or more sites.

30. A system for managing vehicles available for automated rental at a site, called rental site, comprising a plurality of vehicles, said system comprising:
sensors, arranged at said rental site or on said vehicles, for collecting data relating to an operational status of each of said vehicles or of an element of each of said vehicles;
at least one means of identification of a user by means of at least one item of identification data, said means of identification comprising a reader of said identification data from an identification card;
at least one means of selecting a vehicle from said plurality of vehicles as a function of at least one predetermined criterion, called allocation criterion, and of said data relating to each of the vehicles of said plurality, said means of selecting being capable of selecting a vehicle at another rental site remote from said rental site as a function of at least one allocation criterion and a distance criterion of said other remote rental site from said rental site, when no vehicle can be selected at the rental site where the identification step is carried out; and
means for the remote reservation of the selected vehicle.
